(19) United States
(12) Patent Application Publication
(10) Pub. No.: US 2002/0140716 A1
(43) Pub. Date: Oct. 3, 2002

(54) Method for managing skills and method for displaying skill states of a learner based on relationships among the skills

(75) Inventor: Yasunori Satoh, Ota (JP)

Correspondence Address: STAAS & HALSEY LLP, 700 11TH STREET, NW, SUITE 500, WASHINGTON, DC, 20001, US

(73) Assignee: FUJITSU LIMITED, Kawasaki (JP)

(21) Appl. No.: 10/107,199

(22) Filed: Mar. 28, 2002

(30) Foreign Application Priority Data
Mar. 30, 2001 (JP) 2001-102601

(51) Int. Cl. G09G 5/00

(52) U.S. Cl. 345/700

(57) ABSTRACT

In a method for managing a skill of a learner, it is determined based on an obtained date when the learner obtained the skill, whether or not the skill obtained by the learner passes a valid term, and a skill level is changed based on a result.

### BACKGROUND OF THE INVENTION

1. Field of the Invention

The present invention generally relates to a method for managing skills and a computer-readable recording medium recorded with program code for causing a computer to manage skills in which the validity of each of the skills of a learner is determined depending on the passage of time, and a method for displaying skill states of a learner based on relationships among the skills and a computer-readable recording medium recorded with program code for causing a computer to display skill states of a learner based on relationships among the skills.

2. Description of the Related Art

In a conventional skill management method, in order to manage what skills a learner obtains, the presence of each skill is managed by recording skill items based on a standard list.

Furthermore, a current state and a target are recorded in personal skill information and the personal skill information is utilized based on a difference between the current state and the target.

However, there are the following disadvantages in the conventional skill management method.

In the conventional skill management method, management based on the standard list does not work well in that the learner maintains skills, and the standard list is not easily reviewed and not useful. In addition, even if the skill is recorded, when the learner has not utilized the skill for a long term, the skill becomes useless in practice. Or, when the skill is actually needed, the skill mastered by the learner is degraded. Thus, the skill mastered by the learner is not effectively utilized. Therefore, it is difficult for the conventional skill management method to recognize a degradation of a mastered skill. Moreover, there is no useful method for systematically managing the skills that would be degraded. Accordingly, it can be conducted to warn the learner or to predict inadequate skills in practical use in an organization. Consequently, even if skill information is collected from each learner, when the skill shown in the skill information is not fully utilized, an operation of skill management becomes a mere formality.

### SUMMARY OF THE INVENTION

It is a general object of the present invention to provide a method for managing skills and a method for displaying skill states in that the above-mentioned problems are eliminated.

A first specific object of the present invention is to provide a method for managing skills in which the validity of each of the skills of a learner is determined depending on a passage of time.

A second specific object of the present invention is to provide a method for displaying skill states of a learner based on relationships among the skills.

The above first object of the present invention is achieved by a method for managing a skill of a learner, comprising the steps of: (a) determining based on an obtained date when the learner obtained the skill whether or not the skill obtained by the learner passes a valid term; and (b) changing a skill level based on a result in said step (a).

In the method according to the present invention, the validity of the skill obtained by the learner is determined, and based on the determination result, the skill level is changed. Therefore, it is possible to dynamically manage the skill related to the learner.

Alternatively, the above first object of the present invention may be achieved by a computer-readable recording medium having a program recorded thereon for causing a computer to manage a skill of a learner.

Moreover, the above second object of the present invention is achieved by a method for displaying a skill state of a learner, comprising the steps of: (a) managing skill information showing a skill related to the learner for each learner; (b) managing skill related information showing relationships with other skills for each skill; and (c) displaying the skill information of the learner by the relationship at a display unit based on the skill related information.

In the method described above, the skills obtained by the learner are related each other and displayed at the display unit. Therefore, it is possible to systematically know the skills obtained by the learner.

### BRIEF DESCRIPTION OF THE DRAWINGS

Other objects, features, and advantages of the present invention will become more apparent from the following detailed description when read in conjunction with the accompanying drawings, in which:

FIG. 1 is a diagram showing a principle functional configuration of a skill managing apparatus according to an embodiment of the present invention;

FIG. 2 is a diagram showing a hardware configuration of the skill managing apparatus;

FIG. 3A and FIG. 3B are flowcharts for explaining a skill updating process;

FIG. 4 is a flowchart for explaining the skill updating process;

FIG. 5 is a flowchart for explaining the skill updating process;

FIG. 6 is a flowchart for explaining the skill updating process;

FIG. 7 is a diagram illustrating a skill system table;

FIG. 8 is a diagram illustrating a skill-task correspondence table;

FIG. 9 is a diagram illustrating a skill-course correspondence table;

FIG. 10 is a diagram illustrating a personal skill information table;

FIG. 11 is a diagram illustrating a skill-qualification correspondence table;

FIG. 12 is a diagram illustrating an education course attendance information DB FIG. 13 is a diagram illustrating an activity achievement information DB;

FIG. 14 is a diagram illustrating a personal information DB;

FIG. 15 is a diagram illustrating a basic display example of a skill information; and

FIG. 16 is a diagram illustrating a display example of a detailed skill state.

### DESCRIPTION OF THE PREFERRED EMBODIMENTS

An embodiment of the present invention will be described with reference to figures.

For example, a skill managing apparatus applying a method for managing skills according to the embodiment of the present invention includes a principle functional configuration as shown in FIG. l.

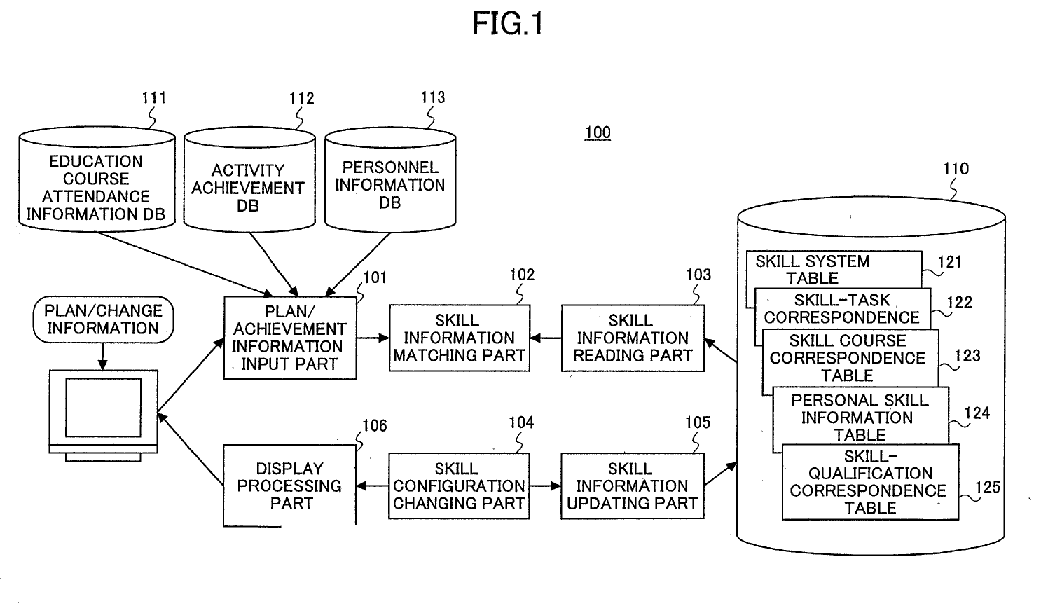

FIG. 1 is a diagram showing the principle functional configuration of the skill managing apparatus.

In FIG. 1, the skill managing apparatus 100 includes a plan/achievement information input part 101, a skill information matching part 102, a skill information reading part 103, a skill configuration changing part 104, a skill information updating part 105, a display processing part 106, a skill table managing part 110, an education course attendance information DB (database) 111, an activity achievement DB 112, and a personnel information DB 113.

The plan/achievement information input part 101 sets skills as targets that correspond to task contents and should be obtained in the future based on the activity achievement DB 112 and personnel information DB 113, and obtains information of qualifications obtained by the learner as information of achievements.

The skill information matching part 102 matches input information from the learner obtained by the plan/achievement information input part 101 with information read by the skill information reading part 103 from the skill table managing part 110.

The skill information reading part 103 reads information from the skill table managing part 110, and provides the information to the skill information matching part 102.

The skill configuration changing part 104 changes a skill configuration based on a matching result by the skill information matching part 102, and provides a change result to the skill information updating part 105 and the display processing part 106.

The skill information updating part 105 changes each of tables 121 through 125 managed by the skill table managing part 110 based on the change result supplied from the skill configuration changing part 104.

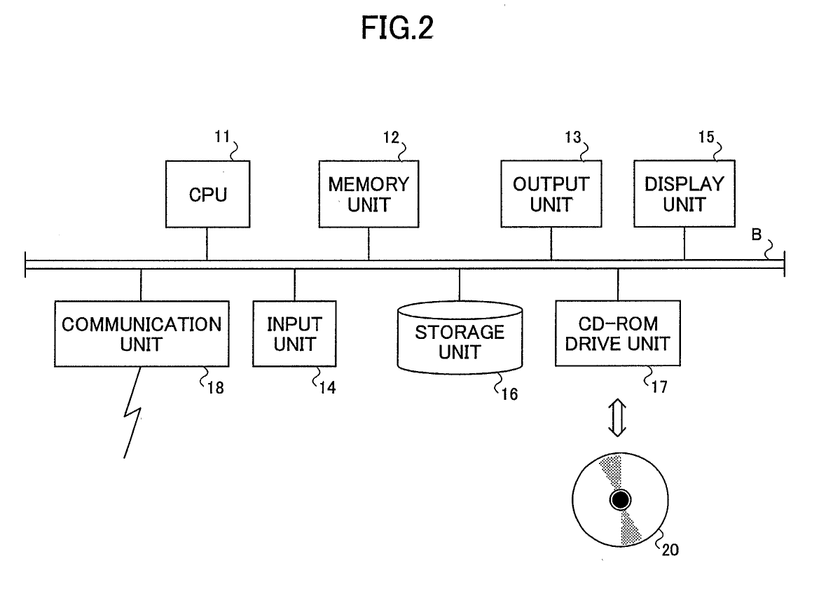

The display processing part 106 generates a display screen systematically showing categories of the skills, target skills, obtained skills, and invalid skills based on the change result supplied from the skill configuration changing part 104, and displays the display screen to a display unit 15 (shown in FIG. 2).

The skill table managing part 110 manages a skill system table 121 showing information systematically relating among the skills, a skill-task correspondence table 122 showing skill information obtainable for each task, a skill course correspondence table 123 showing the skill information obtainable for each course, a personal skill information table 124 showing the skill information of each learner, and a skill-qualification correspondence table 125 showing the skill information obtainable for each qualification.

The education course attendance information DB 111 stores information related to courses that each employee attended.

The activity achievement DB 112 stores information related to tasks that each employee has conducted.

The personnel information DB 113 stores information related to qualifications obtained by the employee or evaluations respective to tasks.

The skill system table 121, the skill-task correspondence table 122, the skill course correspondence table 123, the personal skill information table 124 showing the skill information of each learner, the skill-qualification correspondence table 125, the education course attendance information DB 111, the activity achievement DB 112, and the personnel information DB 113, which are managed by skill table managing part 110, are stored in a storage unit 16 shown in FIG. 2.

For example, a computer system, in which the method for managing skills according to the embodiment of the present invention is applied to the skill managing apparatus 100, includes a hardware configuration as shown in FIG. 2.

In FIG. 2, the skill managing apparatus 100 includes a CPU (Central Processing Unit) 11, a memory unit 12, an output unit 13, an input unit 14, a display unit 15, the storage unit 16, a CD-ROM drive unit 17, and a communication unit 18, which are mutually connected by a bus B.

The CPU 11 controls the skill managing apparatus 100 in accordance with programs stored in the memory unit 12, and conducts a process in the skill managing apparatus 100 that will be described later. The memory unit 12 includes a RAM (Random Access Memory) and a ROM (Read Only Memory), and stores the programs executed by the CPU 11, data necessary for the processes in the CPU 11, data obtained during the process in the CPU 11, and a like. In addition, the memory unit 12 is partially assigned as a working area used for the processes in the CPU 11.

The output unit 13 includes a printer or the like, and outputs a process result or information indicated by the CPU 11. The input unit 14 includes a mouse, a keyboard, and the like, and is used to register for conducting the process in the skill managing apparatus 100 and change data registered, and is used to input various necessary information. The display unit 15 displays various information necessary for learners under control of the CPU 11.

For example, the storage unit 16 includes a hard disk unit, and stores various files and programs.

The programs according to the process in the skill managing apparatus 100 are provided to the skill managing apparatus 100 by a CD-ROM 20. That is, when the CD-ROM 20 storing the programs according to the process in the skill managing apparatus 100 is set to the CD-ROM drive unit 17, the CD-ROM drive unit 17 reads the programs from the CD-ROM 20. The programs read from the CD-ROM 20 are installed in the storage unit 16 via the bus B. When the process is executed, the CPU 11 starts the process in accordance with the programs installed in the storage unit 16. A recording medium storing the programs is not limited to the CD-ROM 20 but any computer-readable recording medium can be used.

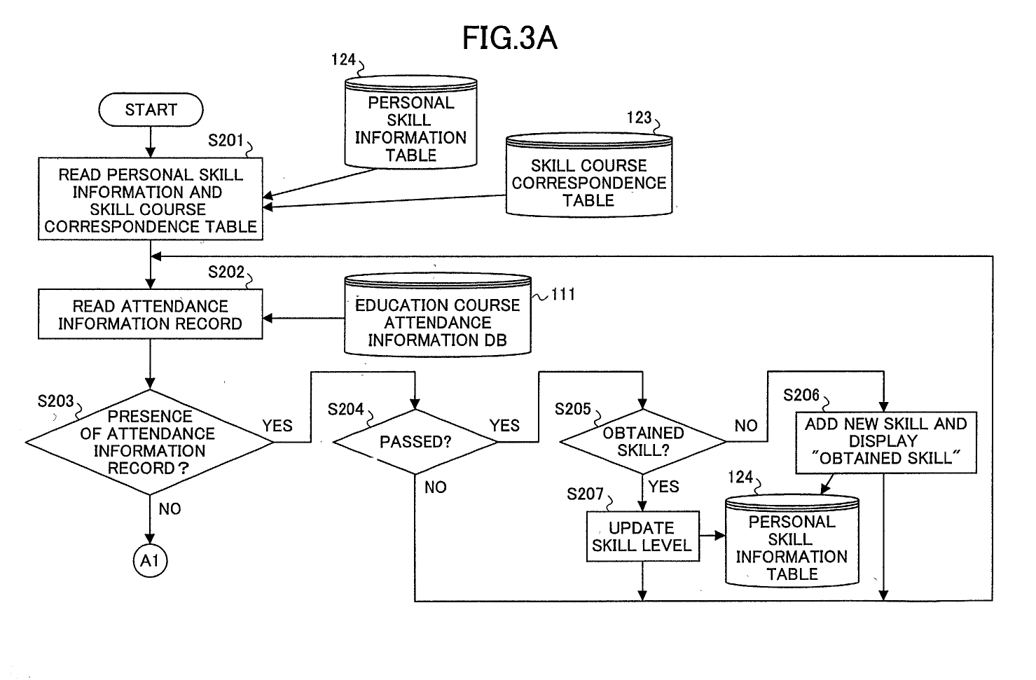

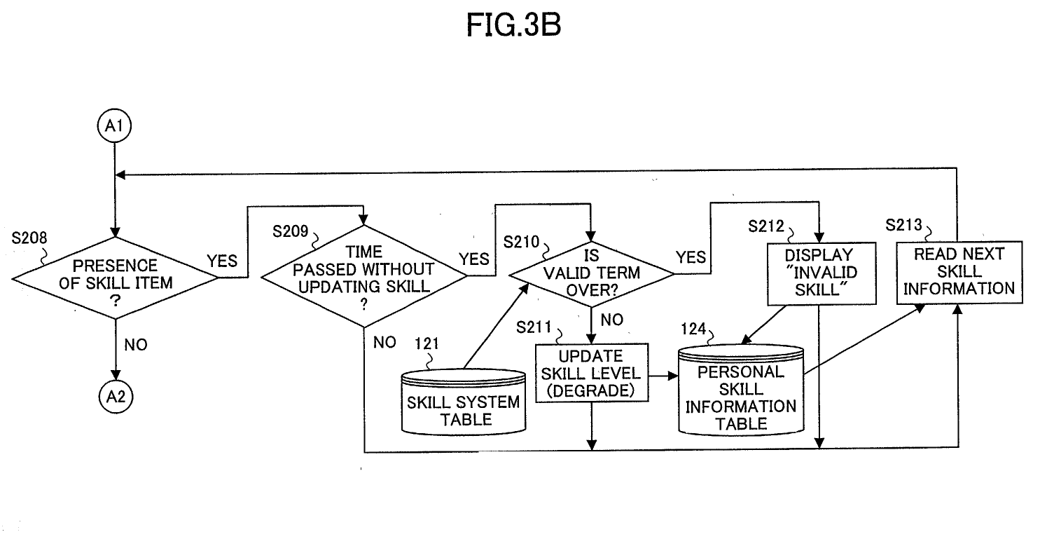

Next, steps executed by the CPU 11 of the skill managing apparatus 100 will be described with reference to FIG. 3A and FIG. 3B and FIG. 4 through FIG. 6.

FIG. 3A and FIG. 3B are flowcharts for explaining a skill updating process.

In step S201 in FIG. 3, the skill information reading part 103 reads the personal skill information table 124 and the skill course correspondence table 123 from the skill table managing part 110.

In step S202, one attendance information record is read from the education course attendance information DB 111.

In step S203, a presence of the attendance information record is checked. When it is determined that the attendance information record does not exist, the skill updating process goes to step S208. On the other hand, When it is determined that the attendance information record exists, the skill updating process goes to step S204.

In step S204, it is determined whether or not an employee shown in the attendance information record successfully passed the skill course. When it is determined that the employee failed to pass the skill course, the skill updating process goes back to step S202. On the other hand, when it is determined that the employee successfully passed the skill course, the skill updating process goes to step S205.

In step S205, it is determined whether or not the employee has already obtained the skill. When it is determined that the employee has not obtained the skill, step S206 is executed. In step S206, a new skill is added to the personal skill information table 124, and “OBTAINED SKILL” is displayed at the display unit 15. The skill updating process goes back to step S202 to conduct the same steps for next attendance information record.

On the other hand, when it is determined that the employee has been already obtained the skill, the skill level is updated (step S207). That is, the skill updating process updates the skill level in the personal skill information table 124, and goes back to step S202 to conduct the same steps for next attendance information record.

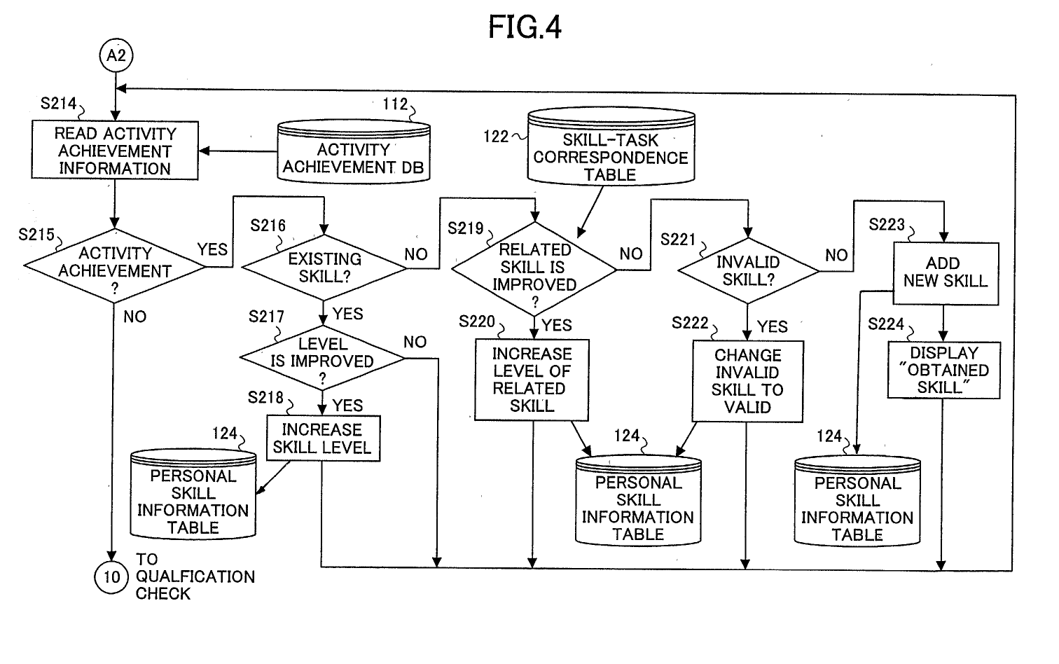

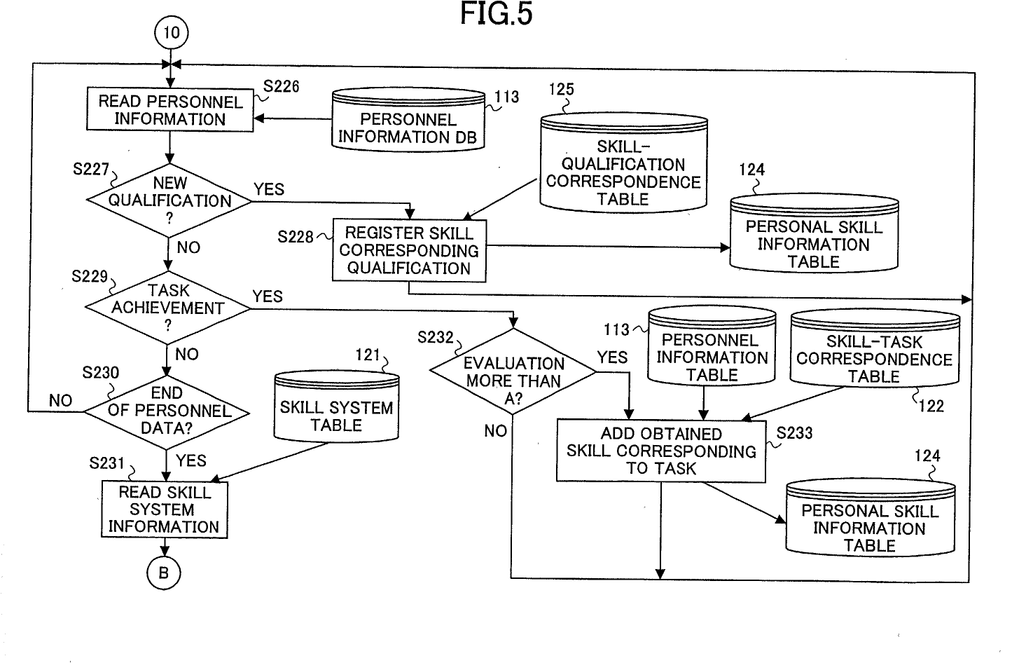

In step S208, it is determined whether or not a skill item exists. When it is determined that there is no skill item, the skill updating process goes to step S214 shown in FIG. 4. On the other hand, when it is determined that there is the skill item, the skill updating process goes to step S209. In step S209, it is determined whether or not a time has passed without updating the skill. When it is determined that the time has not passed (NO in step S209), the skill updating process goes to step S213. On the other hand, when it is determined that the time has passed without updating the skill (YES in step S209), the skill updating process goes to step S210.

In step S210, the skill updating process reads the skill system table 121, and determines whether or not a valid term is over. When the valid term is not over (NO in step S210), the skill updating process goes to step S211. In step S211, the skill level is updated. That is, the skill updating process degrades the skill level in the personal skill information table 124, and goes to step S213. On the other hand, when the valid term is over (YES in step S210), the skill updating process goes to step S212. In step S212, the skill updating process displays “INVALID SKILL”. That is, the skill is set to be invalid in the personal skill information table 124, and the skill updating process goes to step S213.

In step S213, the skill updating process reads next skill information record and goes back to step S208 to repeat the same steps.

In step S214 in FIG. 4, the skill updating process reads the activity achievement DB 112. Subsequently, in step S215, it is determined whether or not there is an activity achievement. When there is an activity achievement (YES in step S214), the skill updating process goes to step S226.

On the other hand, when there is no activity achievement (NO in step S214), the skill updating process goes to step S216. In step S216, it is determined whether or not the skill information shows an existing skill. When the skill information shows an existing skill (YES in step S216), it is determined whether or not the skill level is improved (step S217). When it is determined that the skill level is not improved (NO in step S217), the skill updating process goes back to step S214, and repeats the same steps. On the other hand, when it is determined that the skill level is improved (YES in step S217), the skill level is incremented and the personal skill information table 124 is updated (step S218). Then, the skill updating process goes back to step S214 to repeat the same steps.

On the other hand, when the skill information does not show an existing skill, the skill updating process refers to the skill-task correspondence table 122 in step S219, and then determines whether or not a related skill is improved. When the related skill is not improved (NO in step S219), the skill updating process goes to step S221. On the other hand, when the related skill is improved (YES in step S219), the skill level of the related skill is incremented and the personal skill information table 124 is updated (step S220). Then, the skill updating process goes to step S214 to repeat the same steps.

In step S221, it is determined whether or not there is an invalid skill. When there is no invalid skill (NO in step S221), the skill updating process goes to step S223. On the other hand, when it is determined that there is an invalid skill (YES in step S221), the skill updating process changes the invalid skill to the valid skill and the personal skill information table 124 is updated (step S222), and goes back to step S214 to repeat the same steps.

In step S223, the new skill is added and the personal skill information table 124 is updated. Subsequently, in step S224, the skill updating process displays “OBTAINED SKILL”.

In step S226 in FIG. 5, the skill updating process reads the personal information from the personnel information DB 113.

In step S227, based on the personal information read from the personnel information DB 113, it is determined whether or not there is a new qualification. When there is no new qualification, the skill updating process goes to step S229. On the other hand, when it is determined that there is the new qualification, based on the skill-qualification correspondence table 125, the skill updating process registers a skill corresponding to a qualification to the personal skill information table 124 in step S228, and then goes back to step S226.

In step S229, it is determined whether or not there is a task activity. When there is no task activity (NO in step S229), the skill updating process goes to step S230. On the other hand, when there is a task activity (YES in step S229), the skill updating process goes to step S232.

In step S232, it is determined whether or not an evaluation is more than or equal to a grade A. When the evaluation is not more than or equal to the grade A (NO in S232), the skill updating process goes back to step S226 to read next personal information from the personnel information DB 113 and repeat the same steps.

On the other hand, when the evaluation is more than or equal to the grade A (YES in S232), based on the personnel information DB 113 and the skill-task correspondence table 122, the skill updating process adds the obtained skill corresponding to a task to the personal skill information table 124 (step S233), then goes back to step S226 to read the next personal information and repeat the same steps.

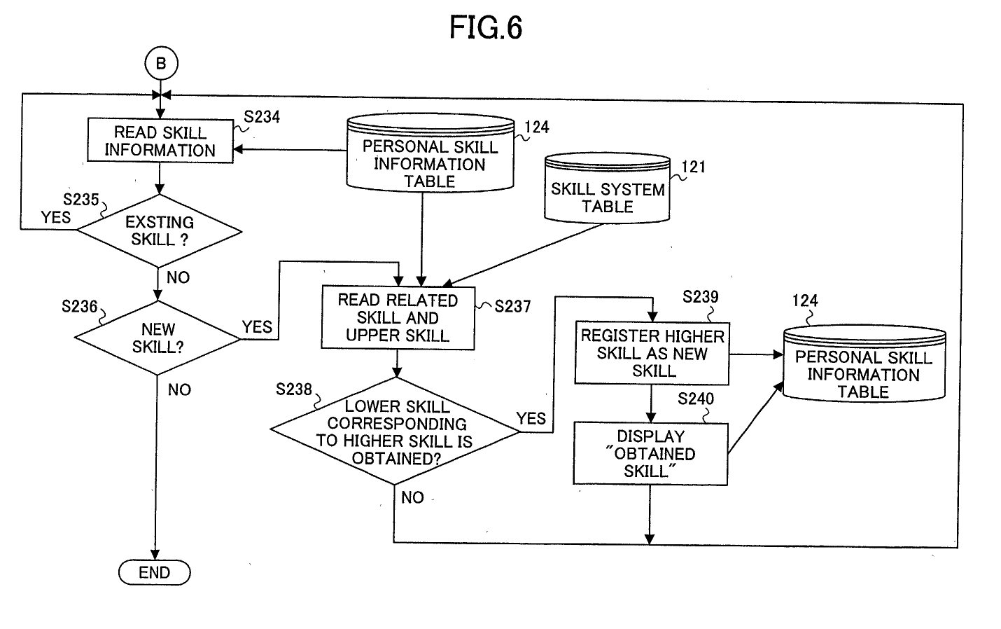

On the other hand, in step S230, it is determined whether or not it is the end of the personal information in the personnel information DB 113. When it is not the end of the personal information, the skill updating process goes back to step S226 to read the next personal information and repeat the same steps. On the other hand, when it is the end of the personal information, the skill updating process reads the skill system information from the skill system table 121 (step S231) and then executes step S234 in FIG. 6.

In step S234 in FIG. 6, the skill updating process reads the skill information from the personal skill information table 124.

In step S235, it is determined whether or not the skill information shows the existing skill. When the skill information shows the existing skill, the skill updating process goes back to step S234 to read next skill information from the personal skill information table 124 and repeat the same steps. On the other hand, when the skill information does not show the existing skill, the skill updating process determines whether or not the skill information shows the new skill (step S236). When the skill information does not show the new skill (NO in step S236), the skill updating process is terminated.

On the other hand, when the skill information shows the new skill (YES in step S236), the skill updating process reads the related skills and higher skills based on the personal skill information table 124 and the skill system table 121 (step S237), and determines whether or not the employee has already obtained a lower skill corresponding to the higher skill (step S238). When it is determined that the employee has not obtained the lower skill, the skill updating process goes back to step S234 to read next skill information from the personal skill information table 124 and repeat the same steps. On the other hand, when the employee has already obtained the lower skill, the skill updating process registers the higher skill as the new skill to the personal skill information table 124 (step S239) and displays “OBTAINED SKILL” at the display unit 15 (step S240). Subsequently, the skill updating process goes back to step S234 to read next skill information from the personal skill information 124 and repeat the same steps.

As described above, in steps S203, S204, S205, and S207 in FIG. 3A, the skill updating process upgrades the skill level based on the attendance information showing that the employee passes. In steps S209, S210, and S211 in FIG. 3B, the skill updating process degrades the skill level depending an time passage. In addition, in steps S215, S216, S217, and S218 in FIG. 4, the skill updating process upgrades the skill level depending on the activity achievement. Accordingly, it is possible to dynamically change the skill level.

Moreover, in steps S234 through S236 in FIG. 6, the skill updating process displays a skill range for each employee.

Next, the tables 121 through 125 managed by the skill managing apparatus 100 will be described.

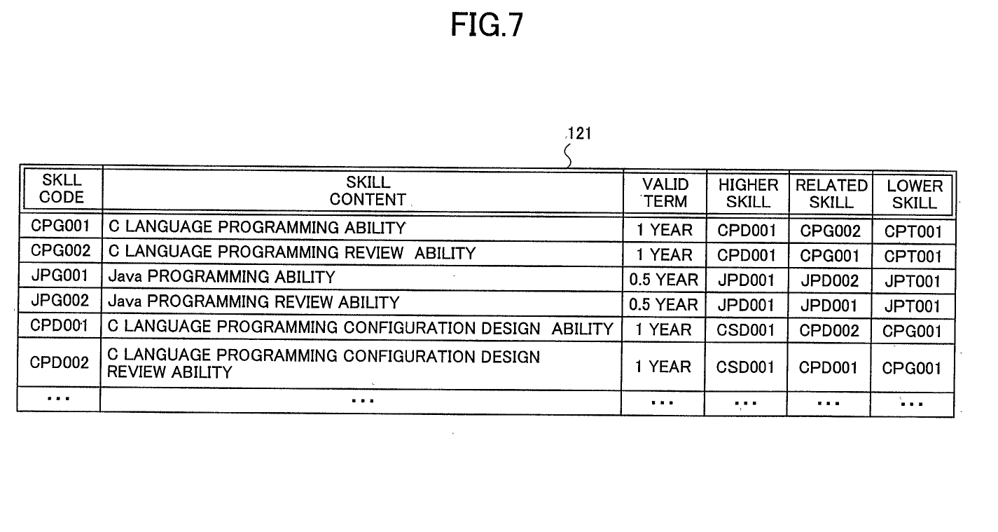

FIG. 7 is a diagram illustrating the skill system table.

In FIG. 7, the skill system table 121 includes a skill code, a skill name, the valid term, the higher skill, the related skill, the lower skill, and the like as items.

The skill code is information to specify the skill, and for example, is shown as “CPG001”.

The skill name is information to simply show a skill content, and for example, is shown as “C LANGUAGE PROGRAMMING ABILITY”. Also, the skill name or the skill code is used to be a first key to search for information related to the skill.

The valid term is information to show a term at which the skill can be maintained after obtaining the skill, and for example, is shown as “ONE YEAR”.

The higher skill is a skill code to show the higher skill that is recommended for step up, and for example, is shown as “CPD001”.

The related skill is the skill code to show an equal skill level that is recommended to extend a skill range, and for example, is shown as “CPG002”.

The lower skill is the skill code to show the skill level right under the skill, and for example, is shown as “DPT001”.

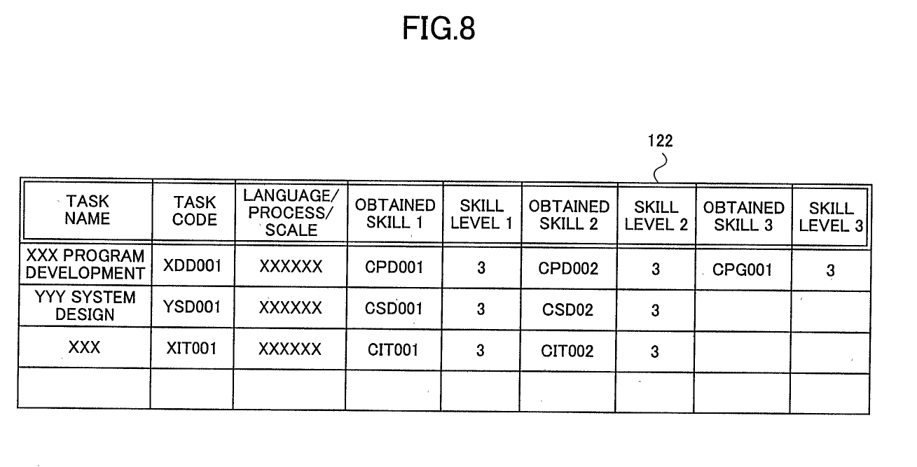

FIG. 8 is a diagram illustrating the skill-task correspondence table.

In FIG. 8, the skill-task correspondence table 122 includes a task name, a task code, a language/process/scale, an obtained skill, a skill level 1 indicating a level 1 of the skill, an obtained skill 2, a skill level 2 indicating a level 2 of the skill, an obtained level 3, a skill level 3 indicating a level 3 of the skill, and the like as items.

The task name is information showing the task, and for example, is shown as “XXX PROGRAM DEVELOPMENT”.

The task code is information to specify the task, and for example, is shown as “XDD001”.

The language/process/scale is information to show a task scale.

The obtained skill 1, the obtained skill 2, and the obtained skill 3 are information to show skill codes specifying skills obtained by tasks, and for example, are shown as “CPD001”, “CPD002”, and “CPG001”, respectively.

The skill level 1, the skill level 2, and the skill level 3 are information to show obtained skill levels, and for example, are shown as “3”, “3”, and “3”, respectively.

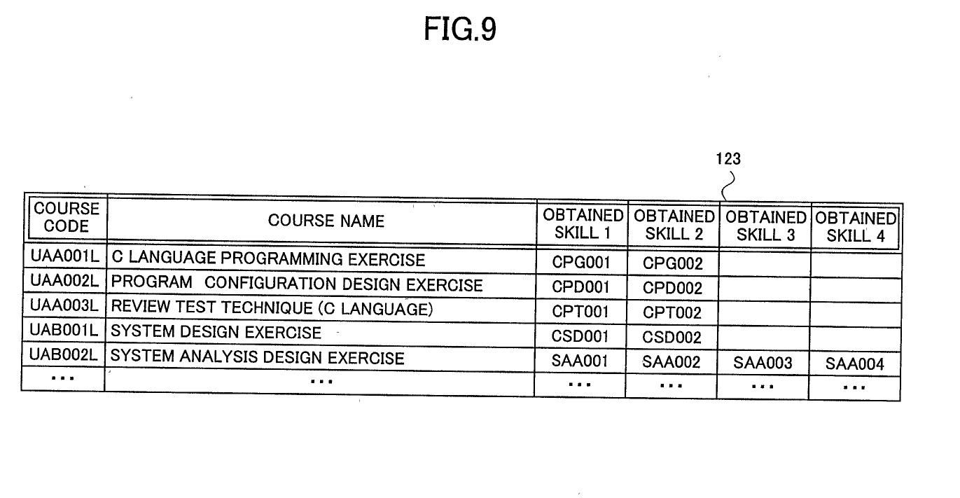

FIG. 9 is a diagram illustrating the skill-course correspondence table.

In FIG. 9, the skill-course correspondence table 123 includes a course code, a course name, the obtained skill 1, the obtained skill 2, the obtained skill 3, an obtained skill 4, and the like as items.

The course code is information to specify the course, and for example, is shown as “UAA001L”.

The course name is a name to simply show the course content, and for example, is shown as “C LANGUAGE PROGRAMING EXERCISE”. In addition, the course name or course code is used as a first key.

The obtained skill 1, the obtained skill 2, the obtained skill 3, and the obtained skill 4 are skill codes to show a skill that can be obtained after finishing the course, and for example, are shown as “CPG001” as the obtained skill 1, “CPG002” as the obtained skill 2, and the like.

In the personal skill information table 124, the skill-course correspondence table 123 is related to the education course attendance information DB 111 by the course code. Also, in the personal skill information table 124, the skill-course correspondence table 123 is related to the skill system 121 by the obtained skill 1, the obtained skill 2, the obtained skill 3, and the obtained skill 4, so as to show information related to the skill obtained after the course is completed (the employee passes the course) for each employee.

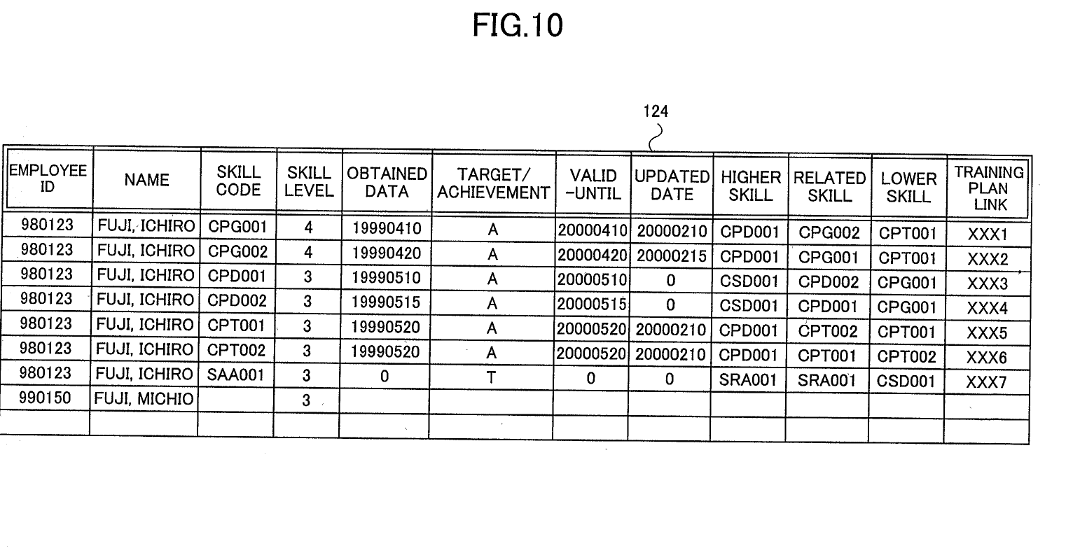

FIG. 10 is a diagram illustrating the personal skill information table.

In FIG. 10, the personal skill information table 124 includes an employee number, a name, a skill code, a skill level, an obtained date, a target/achievement, a valid-until, an updated date, the higher skill, the related skill, the lower skill, a training plan link, and the like as items.

The employee number is a number to specify the employee, and for example, is shown as “980123”.

The name is a name of the employee, and for example, is shown as “FUJI, ICHIRO”.

The skill code is a code corresponding the skill that the employee obtained, and for example, is shown as “CPG001”. The skill level is a skill level of the employee with respect to the skill indicated by the skill code, and for example, is shown as “4”.

The obtained date is set in a case of showing “A” as an achievement in the target/achievement, and shows a date when the employee obtained the skill indicated by the skill code. For example, the obtained date is shown as “19990410”.

The valid-until is a final date that the skill obtained by the employee is recognized as valid and is set based on the skill system table 121. For example, if the valid term of the skill indicated by the skill code “CPG001” shows “ONE YEAR” (FIG. 7), a date “20000140” indicating one year after the obtained date “19990410” is set.

In addition, the updated data is a date when the skill indicated by the skill code is updated after the employee obtained the skill, and for example is shown as “20000210”.

The higher skill, the related skill, and the lower skill are set as the higher skill, the related skill, and the lower skill corresponding to the skill codes of the skill system table 121 in FIG. 7.

The training plan link is set as a link linking an improvement plan of the skill indicated by the skill code.

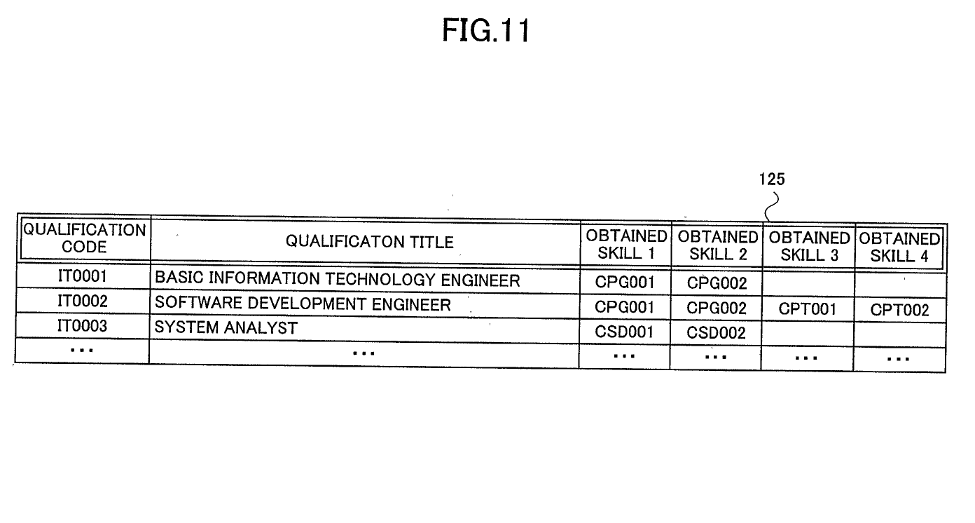

FIG. 11 is a diagram illustrating the skill-qualification correspondence table.

In FIG. 11, the skill-qualification correspondence table 125 includes a qualification code, a qualification name, the obtained skill 1, the obtained skill 2, the obtained skill 3, the obtained skill 4, and the like as items.

The qualification code is information to specify an obtained qualification, and for example, is shown as “IT0001”.

The qualification name is a name to simply show a qualification content, and for example, is shown as “BASIC INFORMATION TECHNOLOGY ENGINEER”.

The obtained skill 1, the obtained skill 2, the obtained skill 3, and the obtained skill 4 are skill codes to specify the skills obtained after the employee is qualified in respect to the skills, and for example, are shown as “CPG001” as the obtained skill 1, “CPG002” as the obtained skill 2, and the like.

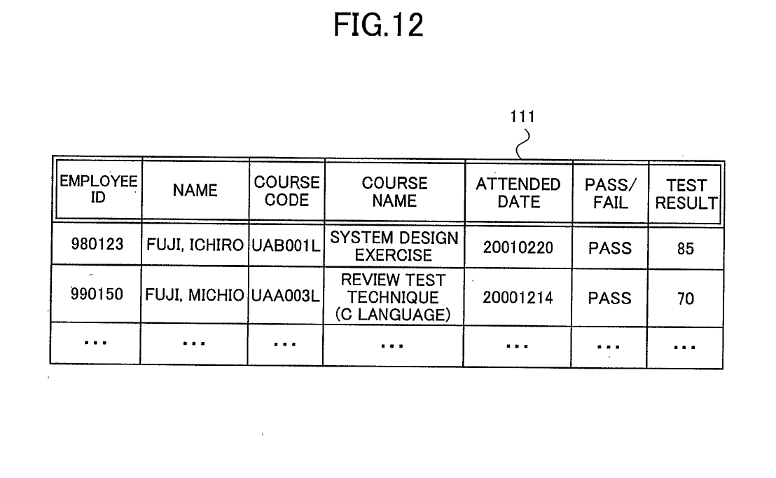

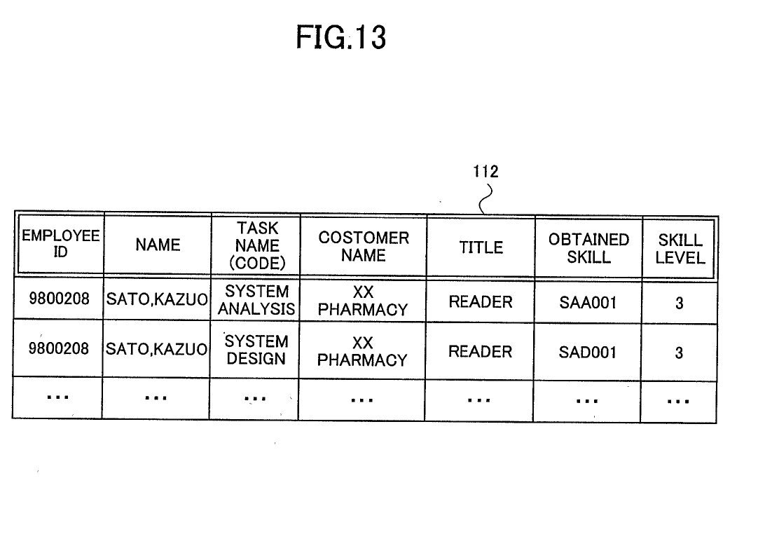

FIG. 12 is a diagram illustrating the education course attendance information DB.

In FIG. 12, the education course attendance information DB 111 includes an employee number, a name, the course code, the course name, an attended date, a pass/fail, a test result, and the like as items.

The employee number is a number to specify the employee, and for example, is shown as “980123”.

The name shows an employee name, and for example, is shown as “FUJI, ICHIRO”.

The course code is information to specify the course, and for example, is shown as “UAB001L”.

The course name is a name to simply show the course content, and for example, is shown as “SYSTEM DESIGN EXERCISE”.

The attended date is information to show a year, a month, and a date when the employee attended the course specified by the course code, and for example, is shown as “20010220”.

The pass/fail is information to show a result from attending the course specified by the course code, and for example, is shown as “P” when the employee passed and like “F” when the employee failed.

The test result shows a point as a result from attending the course specified by the course code, and for example, is shown as “85”.

FIG. 13 is a diagram illustrating the activity achievement information DB.

In FIG. 13, the activity achievement information DB 112 includes the employee number, a name, the task name, a customer name, a title, an obtained skill, the skill level, and the like as items.

The employee number is a number to specify the employee, and for example, is shown as “980208”.

The name shows the employee name, and for example, is shown as “SATO, KAZUO”.

The task name is a name of a task which the employee works for, and for example, is shown as “SYSTEM ANALYSIS”.

The customer name is a name of customer for the task, and for example, is shown as “XX PHERMACY”.

The title is a title of the employee for the task, and for example, is shown as “LEADER”.

The obtained skill shows the skill code of the skill that the employee obtained by the task, and for example, is shown as “SAA001”.

The skill level is a skill level of the skill that the employee obtained, and for example, is shown “3”.

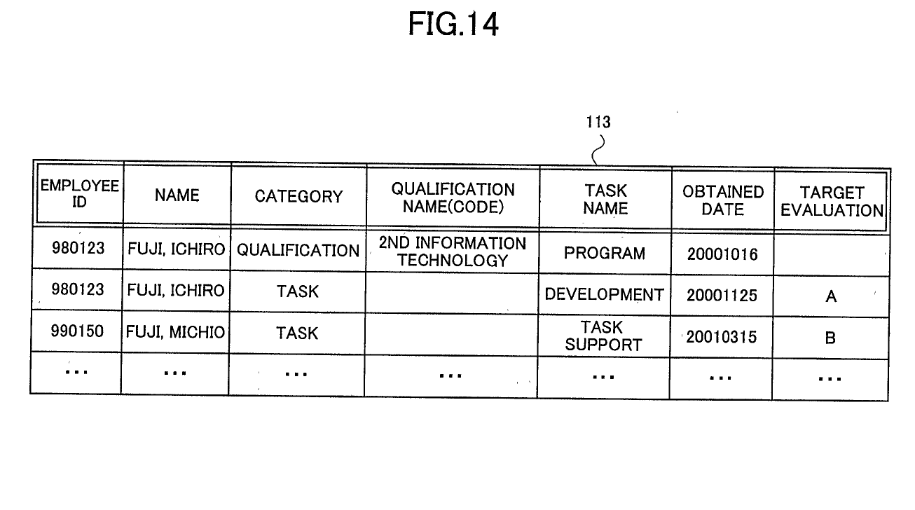

FIG. 14 is a diagram illustrating a personal information DB.

In FIG. 14, the personnel information DB 113 includes the employee number, a name, a category, the qualification name, the task name, the obtained date, a target evaluation, and the like as items.

The employee number is a number to specify the employee, and for example, is shown “980123”.

The name is a name of the employee and for example, is shown as “FUJI, ICHIRO”.

The category shows as “qualification” or as “TASK”.

The qualification name shows a name of the qualification when the category shows “QUALIFICATION”, and for example, is shown as “2ND INFORMATION TECHNOLOGY”.

The task name shows a name of the task when the category shows “TASK”, and for example, is shown as “PROGRAM DEVELOPMENT”.

The obtained date shows a year, a month, and a date when the employee obtained the qualification or when the employee obtained the evaluation of the task, and for example, is shown as “20000116”.

The target evaluation shows an evaluation of the task when the category indicates “TASK”, and for example, is shown as “A”.

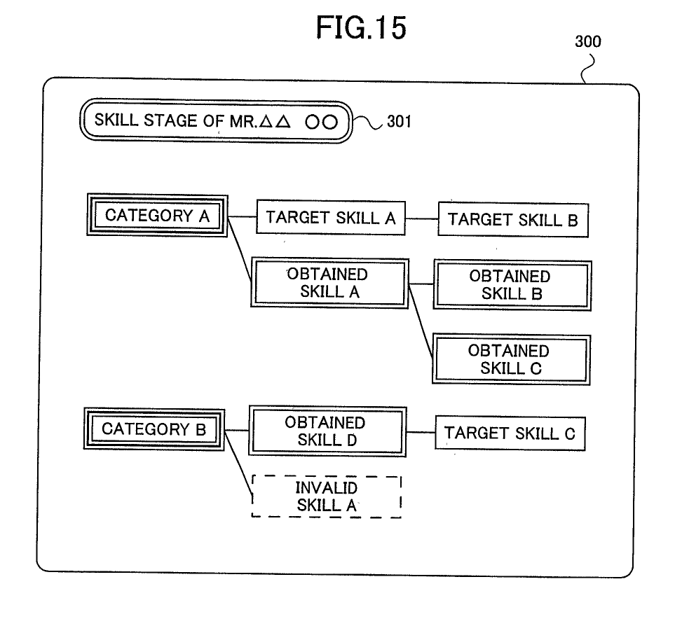

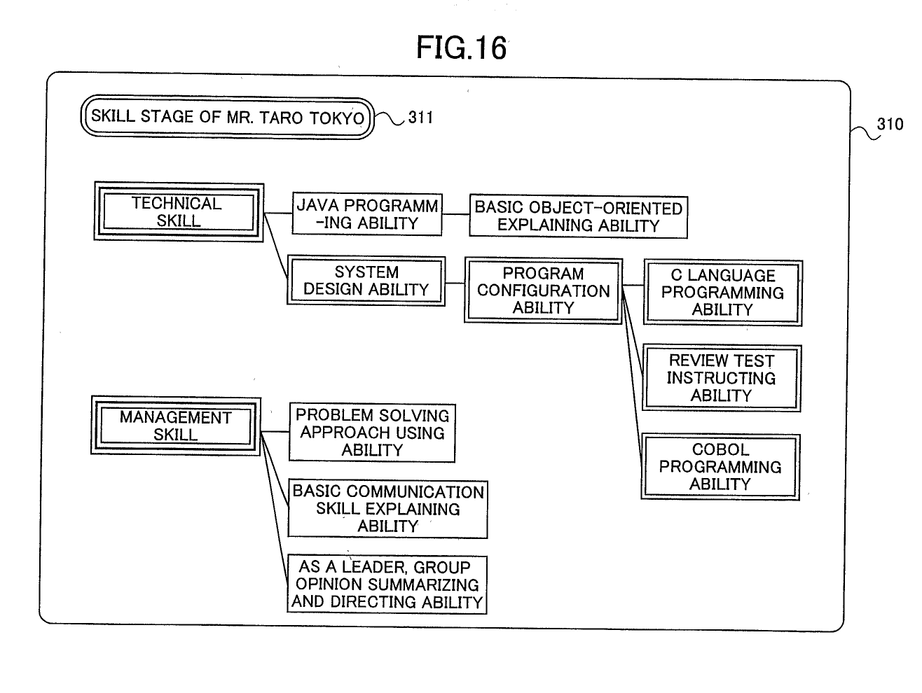

Next, a display example of the skill information displayed at the display processing part 106 will be described with reference to FIG. 15 and FIG. 16.

FIG. 15 is a diagram illustrating a basic display example of displaying the skill information.

In a skill displaying screen 300 in FIG. 15, a learner (employee) is displayed as like “SKILL STATE OF MR.XX OO” at a display area 301. In the skill displaying screen 300, a skill state of Mr.OO is broadly categorized into two skills of a category A and a category B shown in triple line rectangles. The triple line rectangle indicates a skill category.

The category A is further categorized into a target skill A shown in a single line rectangle and an obtained skill A shown in a double line rectangle. The single line rectangle shows the target skill that the Mr.OO set as a target. The double line rectangle shows the skill that Mr.OO obtained after completing the attended course or the task.

Moreover, it can be seen that Mr.OO plans a target skill B following a target skill A shown in the single line rectangle. Based on the skill system table 121, the target skill A is the lower skill of the target skill B and the target skill B is the higher skill of the target skill A.

Furthermore, it can be seen that Mr.OO obtained not only a skill A but also a skill B and a skill C. Based on the skill system table 121, in a case in which the obtained skill B and the obtained skill C are the higher skills of the obtained skill A and are the related skills each other, the obtained skill B and the obtained skill C are displayed in parallel after the obtained skill A.

The category B is categorized into an obtained skill D shown in the double line rectangle and an invalid skill A shown in a dotted line rectangle. The dotted line rectangle indicates that the skill updating process described above determines the valid term of the skill is over. The invalid skill A can be determined as valid based on further task contents in the future, and then can become an obtained skill (step S221 in FIG. 4).

Moreover, Mr.OO plans a target skill C following the obtained skill A to obtain in the future.

As described above, the skill state is not simply displayed as a list but by determining the skill state by the skill updating process, the skill state can be displayed in a systematic tree structure and skills that are validly utilized at present, skills to be targets in the future, and skills that are not necessary at present can be clearly displayed.

Therefore, the learner (employee) can conduct skill management based on a characteristic of the task. Accordingly, it is possible to plan to effectively obtain skills in the future.

In the basic display example in FIG. 15, as a method for showing skill types of the skill category, the target skill, the obtained skill, the invalid skill, and the like, the triple line rectangle, the single line rectangle, the double line rectangle, and the dotted line rectangle are used but the method is not limited to do so. It is preferable to visually display the skill types. Thus, different colors, different shapes, and the like can be used to show the skill types.

Next, a display example of a detailed skill state will be described.

FIG. 16 is a diagram illustrating the display example of the detailed skill state.

In a display example 310 of the detailed skill state in FIG. 15, the learner (employee) name is displayed in a display area 311 as “SKILL STATE OF MR.TARO TOKYO”, and the skill state of the employee “TOKYO, TARO” is displayed.

The employee “TOKYO, TARO” has obtained skills and the target skills to obtain in categories of “TECHNICAL SKILL” and “MANAGEMENT SKILL”.

The category “TECHNICAL SKILL” is categorized into a target skill “JAVA PROGRAMMING ABILITY” and a target skill “SYSTEM DESIGN ABILITY”. There is a target skill “BASIC OBJECT-ORIENTED EXPLAINING ABILITY” following the target skill “JAVA PROGRAMMING ABILITY”, as a future target. Also, it can be seen that the employee “TOKYO, TARO” has already obtained an obtained skill “PROGRAM CONFIGURATION ABILITY” following the obtained skill “SYSTEM DESIGN ABILITY”. Moreover, the employee “TOKYO, TARO” has already obtained an obtained skill “C LANGUAGE PROGRAMMING ABILITY”, an obtained skill “REVIEW TEST INSTRUCTING ABILITY”, and an obtained skill “COBOL PROGRAMMING ABILITY”, as higher skills of the obtained skill “PROGRAM CONFIGURATION ABILITY”.

In the category “MANAGEMENT SKILL”, it can be seen that the employee “TOKYO, TARO” plans a target skill “PROBLEM SOLVING APPROACH USING ABILITY”, a target skill “BASIC COMMUNICATION SKILL EXPLAINING ABILITY”, and a target skill “AS A LEADER, GROUP OPINION SUMMARIZING AND DIRECTING ABILITY”, as future targets.

As described above, since it is possible to display skills currently maintained and skills to obtain in the future, it is possible to clearly show how to develop the skills of the employee in the tasks of the employee.

In the embodiment, as means of the skill management, by including a determining part for determining the valid term of the skill, in a case in which the learner (employee) has not been involved in a task or education corresponding a certain skill, it is possible to change the skill level of the learner depending on the time passage in order to maintain a current skill state.

Moreover, as means of skill management, by relating the higher skill to the lower skill for each skill, in a case in which the lower skill obtained by the task or attending satisfies the education course a predetermined condition, it is possible to automatically set the higher skill as the obtained skill or the target skill.

Furthermore, the skills are not simply managed but the skill state of the learner can be emphasized. It is possible to systematically display the target skills and the obtained skills of the learner in the tree structure.

Moreover, the skill state can be dynamically displayed in views of the time passage, the skill level, and the skill range. It is possible to display that the skill is degraded or that the skill becomes useless, depending on the time passage. That is, it is possible to display so that the number of skills is not simply increased based on the education and experience in the tasks but changed depending on the time passage.

In the embodiment, steps S209 and S210 shown in FIG. 3 correspond to step of determining a valid term, and step S211 shown in FIG. 3 corresponds to step of changing a skill level.

According to the present invention, the validity of the skill obtained by the learner is determined, and based on a determination result, the skill level is changed. Therefore, it is possible to dynamically change and manage the skills related to the learner.

Moreover, according to the present invention, the skills obtained by the learner and related to each other are displayed at the display unit 15. Therefore, it is possible to systematically display the skills obtained by the learner.

The present invention is not limited to the specifically disclosed embodiments, variations and modifications, and other variations and modifications may be made without departing from the scope of the present invention.

The present application is based on Japanese Priority Application No. 2001-102601 filed on Mar. 30, 2001, the entire contents of which are hereby incorporated by reference.

What is claimed is:

1. A method for managing a skill of a learner, comprising the steps of:
(a) determining based on an obtained date when the learner obtained the skill whether or not the skill obtained by the learner passes a valid term; and
(b) changing a skill level based on a result in said step (a).

2. The method as claimed in claim 1, wherein said step (b) invalidates the skill obtained by the learner when the skill passes the valid term.

3. The method as claimed in claim 1, further comprising the step of (c) updating the skill related to an active achievement based on the active achievement of the learner.

4. The method as claimed in claim 3, wherein said step (c) adds a new skill based on the active achievement of the learner.

5. The method as claimed in claim 1, further comprising the steps of:
(d) managing skill information related to the skill obtained by the learner for each learner; and
(e) registering the skill information showing the skill corresponding to a qualification based on qualification information showing the qualification of the learner for each learner.

6. The method as claimed in claim 5, further comprising the steps of:
(f) determining based on task evaluation information showing an evaluation, which the learner obtained by a task, whether or not a level of the learner achieves a predetermined level: and
(g) registering based on a determination result in said step (f) whether or not skill information showing the skill corresponds to the task.

7. A method for displaying a skill state of a learner, comprising the steps of:
(a) managing skill information showing a skill related to the learner for each learner;
(b) managing skill related information showing relationships with other skills for each skill; and
(c) displaying the skill information of the learner by the relationships based on the skill related information at a display unit.

8. The method as claimed in claim 7, wherein said step (b) manages a higher skill being a higher level related to the skill, a same skill being a same level related to the skill, a lower skill being lower level related to the skill, as the skill related information for each skill, and
said step (c) displays the skill information of the learner in a tree structure based on a level order indicated said skill related information.

9. The method as claimed in claim 7, further comprising the steps of:
(d) managing validity information showing a validity of the skill depending on a time passage after the learner obtained the skill; and
(e) managing skill range information showing skills in a predetermined range necessary for a task of the learner;
wherein said step (c) displays the skill information of the learner corresponding to the skill range information and visually displays a presence of the validity based on the validity information.

10. A computer-readable recording medium having a program recorded thereon for causing a computer to manage a skill of a learner, comprising the codes of:
(a) determining based on an obtained date when the learner obtained the skill whether or not the skill obtained by the learner passes a valid term; and
(b) changing a skill level based on a result in said code (a).

11. A computer-readable recording medium having a program recorded thereon for causing a computer to display a skill state of a learner, comprising the codes of:
(a) managing skill information showing a skill related to the learner for each learner;
(b) managing skill related information showing relationships with other skills for each skill; and
(c) displaying the skill information of the learner by the relationships based on the skill related information at a display unit.
